(19) United States
(12) Patent Application Publication
(10) Pub. No.: US 2004/0071147 A1
(43) Pub. Date: Apr. 15, 2004

(54) Communications network

(76) Inventors: Christopher M. Roadknight, Ipswich (GB); Ian W. Marshall, Ipswich (GB)

Correspondence Address: Nixon & Vanderhye, 8th Floor, 1100 North Glebe Road, Arlington, VA, 22201-4714, US

(21) Appl. No.: 10/468,283

(22) PCT Filed: Mar. 1, 2002
(86) PCT No.: PCT/GB02/00903

(30) Foreign Application Priority Data
Mar. 13, 2001 (EP) 01302291.8

(51) Int. Cl. H04L 12/28

(52) U.S. Cl. 370/400

(57) ABSTRACT

The present invention provides an emergent network that is autonomous at the service level. Network nodes have policies that enable them to process different types of service requests, with the processing earning the nodes ‘rewards’. Successful nodes can pass some or all of their policies to other nodes using the evolutionary biology of bacteria as a model. The network is arranged into clusters of nodes, with unprocessed service requests being passed from cluster to cluster.

This invention relates to the field of network management and in particular the management of complex data communication networks.

Communication networks such as the Internet are probably the most complex machines built by mankind. The number of possible failure states in a major network is so large that even counting them is infeasible. Deciding the state that the network is in at any time with great accuracy is therefore not possible. In addition, data networks such as the Internet are subjected to a mixture of deterministic and stochastic load. The network's response to this type of traffic is chaotic, and thus the variation of network state is highly divergent and accurate predictions of network performance require knowledge of the current network state that is more accurate than can be obtained. Future networks, which will have increased intelligence, will be even more complex and have less tractable management. A network management paradigm is required that can maintain network performance in the face of fractal demands without detailed knowledge of the state of the network, and can meet unanticipated future demands.

Biologically inspired algorithms (for example genetic algorithms and neural networks) have been successfully used in many cases where good solutions are required for difficult (here, the term ‘difficult’ is used to represent a problem that is computationally infeasible using brute force methods) problems of this type. They simulate evolutionary procedures or neural activation pathways in software, these then acting as problem solving tools. They can do this because they take a clean sheet approach to problem solving, they can learn from successes and failures and due to multiple adaptive feedback loops, they are able to find optima in a fractal search space quickly.

Stromatolites (S.Golubic “Stromatolites of Shark Bay” pp103-149 in Environmental evolution ed. Margulis and Olendzenski, MIT press 1999) are rock mounds built by heterogeneous colonies of bacteria. Colonies of this type can be found today in Shark Bay, on the coast of Western Australia. Fossil colonies can also be found throughout earth history—currently the oldest known was found in rocks dated at 3.5 Ga, also in Western Australia. The colonies exhibit sophisticated internal organization, that emerges from interactions between individual colony members. In comparison with higher organisms such as ants and termites, the interactions are relatively simple. It is known (see I W Marshall and C Roadknight, “Adaptive management of an active services network”, British Telecom. Technol. J., 18, 4, pp78-84 October 2000) how such colonies can evolve and how this can be applied to the problems of network management. As an illustration of the benefits of emergent colony behaviours, it has also been demonstrated how the colony can be used to generate differentiated quality of service in an autonomous and emergent manner.

According to a first aspect of the present invention there is provided a multi-service communications network comprising a plurality of clusters, each cluster comprising more than one node and being connected to one or more other clusters, each node comprising one or more nodal policy and being configured to process one or more services in accordance with said one or more nodal policy, each nodal policy comprising;

(i) a service request identifier, said service request identifier determining the type of service request that may be processed by each respective node; and

(ii) one or more service request criteria, said service request criteria determining whether a type of service request defined by said service request identifier will be processed by each respective node characterised in that, in use, un-processed service requests are forwarded to other nodes within a cluster and un-processed service requests which reach the perimeter of the cluster are forwarded to one of the connected clusters. Preferably a service request contains a nodal policy. If the activity indicator reaches an upper threshold then the node may replicate all of the nodal policies to generate a clone of the node. If the activity indicator reaches a first lower threshold then the node may import the policy contained in the service request and additionally if the activity indicator reaches a second lower threshold then the node may delete an enabled nodal policy and enable a dormant nodal policy. Alternatively, if the activity indicator reaches a second lower threshold then the node may exchange position with an adjacent node.

Service requests may be injected into the uppermost layer of the cluster. Each node may further comprise a variable that encodes a preference for existing in a defined region of a cluster.

The multi-service communications network may be implemented as described above using a data carrier comprising computer code means.

According to a second aspect of the invention there is provided operating a multi-service communications network as described above.

The invention will now be described, by way of example only, with reference to the following figures in which;

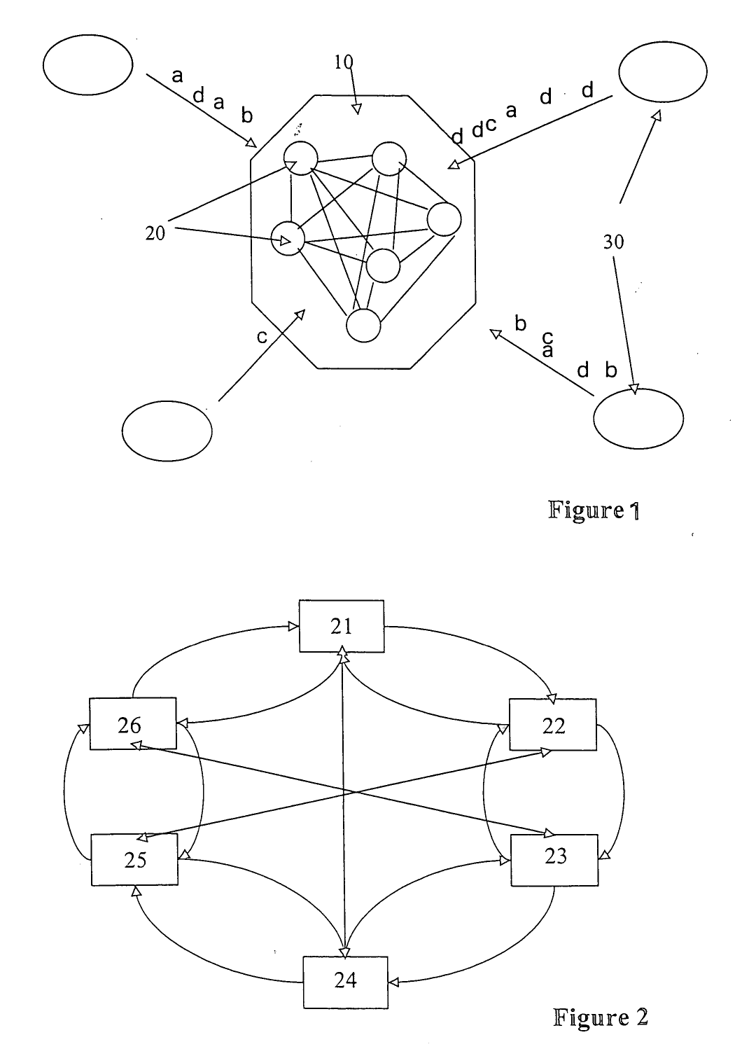

FIG. 1 shows a schematic depiction of a multi-service communications network according to the present invention;

FIG. 2 shows a schematic depiction of the response of a multi-service communications network according to the present invention to different levels of network traffic;

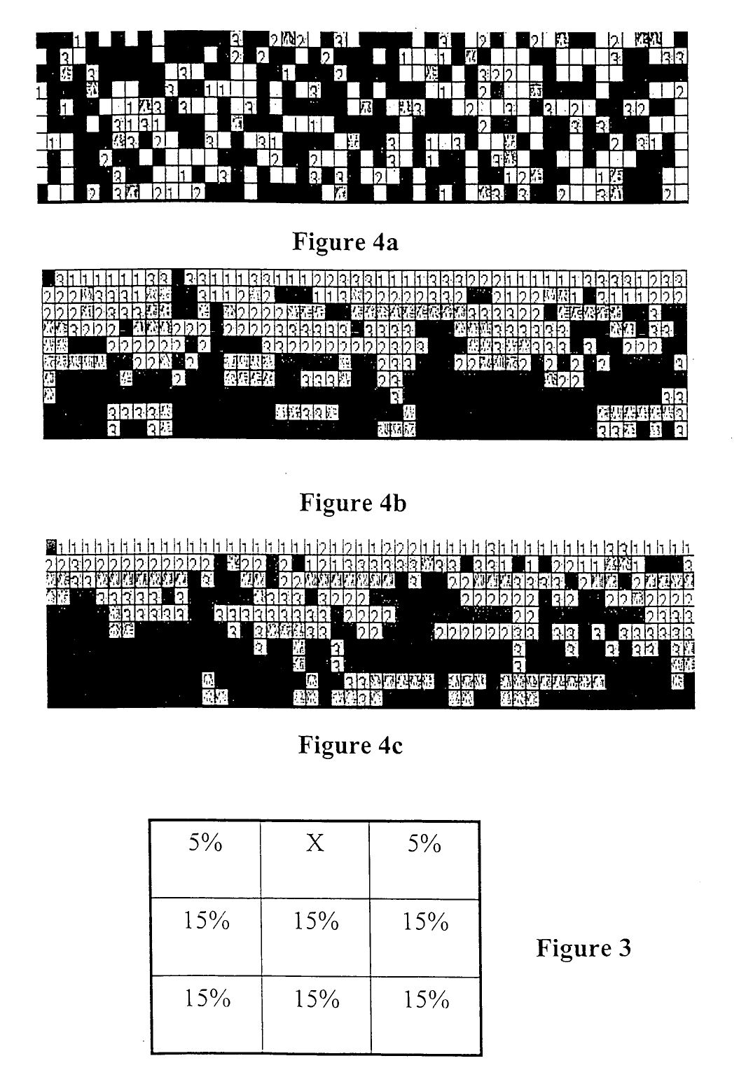

FIG. 3 shows a graphical depiction of the response of a multi-service communications network according to the present invention to the introduction of new service types to the network.

FIG. 4 is a graphical depiction of the simulation of a network cluster according to the present invention; and

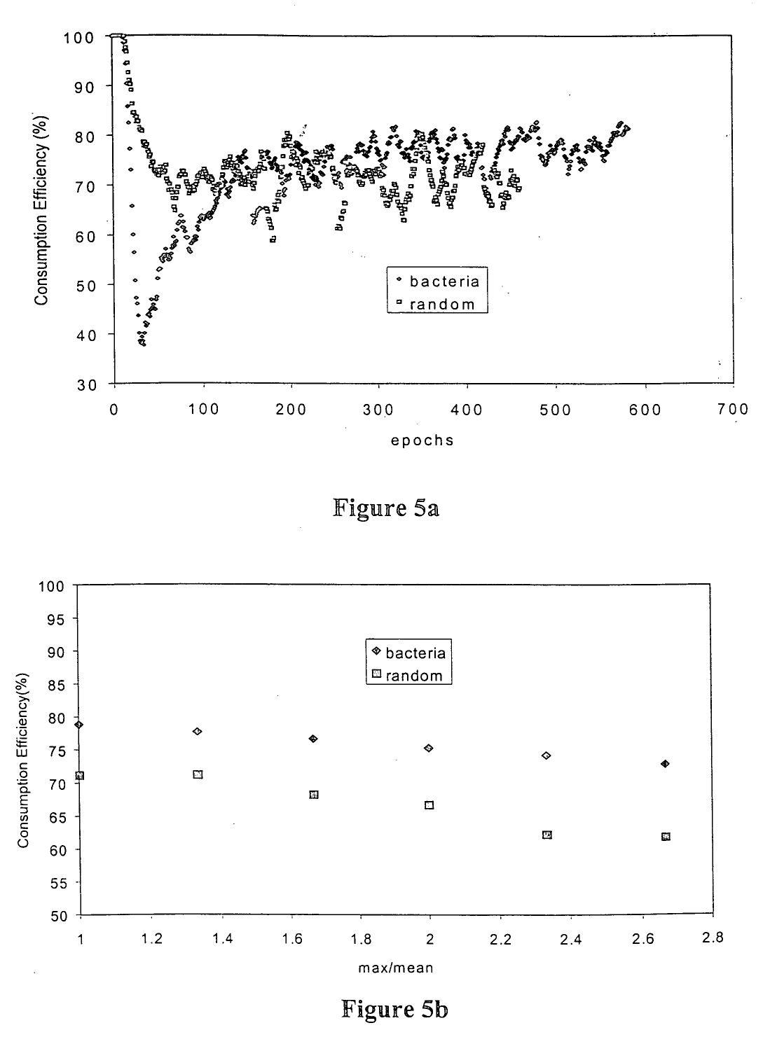

FIG. 5 is a graphical depiction comparing the performance of a network according to the present invention with a conventional network.

FIG. 1 shows a multi-service communications network 10 that comprises a number of inter-connected nodes 20. These nodes are capable of performing one or more of a number of processes which are needed to support the multi-service network 10, for example an ATM switch, WWW server, IP router, SMTP mail server, domain name server (DNS), etc. The users of the multi-service network 10 are divided into a number of communities 30. These communities are geographically dispersed and have different requirements from the multi-service network, in terms of the type of request and the number of requests made (in FIG. 1, the different types of requests are indicated by the letters a, b, c & d, with each letter representing a request for a different service and the frequency of each letter representing the number of requests made for that service). Over time the number of communities 30 using the network 10 will vary and the nature and volume of network usage of each community will vary in a self-similar, deterministic way. Also, the number of services provided by the network will also vary over time as new services are introduced and some services become obsolete and are removed from the network.

One approach to managing such a network would be to make all nodes capable of processing all types of requests and with each node having sufficient capacity to be able to process all of the requests received at that node. However, this would lead to a very inefficient use of resources as virtually every node would be over-dimensioned and have an excess of capacity, both in terms of the type of service requests and the number of service requests that each node would be able to process.

Another approach would be to limit each node to processing a fixed subset of the different services supported by the network and providing a fixed capacity of processing capability for each service type at each node. By placing nodes which can process different types of traffic optimally within the network with respect to the type and number of service requests generated by the nearby communities it will be possible to meet most service requests. There will need to be some management layer within the network so that service requests can be “balanced” across the network, by sending service requests which can not be handled by local nodes to more distant nodes, as the service requests vary across the network. The disadvantage of this approach is that as communities change and the service requirements of the communities change, the location and/or the processing capabilities of the nodes will become less optimal, causing an increase in inter-nodal traffic as service requests are routed to an appropriate node, increasing the management overhead of the network. For a network having N inter-connected nodes there are N² inter-nodal relationships to manage, which makes such a management scheme intractable as N becomes large (for example, much larger than 1000).

One solution to this problem is to make use of nodes which are mostly autonomous and whose behaviour is driven by a set of policies that finds an analogy in the genetic structure of bacteria as are described in international patent applications. This analogy is consistent with the metabolic diversity and the evolutionary responses of bacteria. The Darwinian mechanism of evolution involves a simple ‘survival of the fittest’ algorithm (C Darwin, “The Origin of the Species by Means of Natural Selection”, New American Library, New York). While a Darwinian model is undoubtedly applicable to slowly changing species within a slowly changing environment, the lack of an intra-generational exchange of information mechanism causes problems when applied to environments experiencing very rapid changes.

Bacteria are a set of metabolically diverse, simple, single-cell organisms. Their internal structure is simpler than many other types of living cell, with no membrane-bound nucleus or organelles, and short circular DNA. This is because the genetic structure of bacteria is relatively simple. It has been demonstrated that only around 250 genes are required to code for an independent, self-sustaining bacterium, and highly competent bacteria, for whom the entire genome is known, have only 2000-3000 genes. As a result bacteria can reproduce within 30 minutes of ‘birth’. It has been said that bacterial evolution ‘transcends Darwinism’ (D Caldwell et al, “Do Bacterial Communities Transcend Darwinism?”, Advances in Microbial Ecology. Vol. 15. p.105-191, 1997), with asexual reproduction ensuring survival of the fittest and a more Lamarkian (Lamark was an 18th century French scientist who argued that evolution occurs because organisms can inherit traits, which have been acquired by their ancestors during their lifetime) mechanism of evolution occurring in parallel, with individuals capable of exchanging elements of their genetic material, known as plasmids, during their lifetime in response to environmental stress, and passing the acquired characteristics to their descendants. Plasmid migration allows much quicker reaction to sudden changes in influential environmental factors and can be modelled as a learning mechanism. Sustaining fitness in a complex changing fitness landscape has been shown to require evolution together with a fast learning mechanism. It is vital that the learning is continuous, and does not require off-line training as with many neural-net-based approaches. When a population of E Coli (a common bacterium) is introduced to a new environment, adaptation begins immediately (see RE Lenski and M Travisano “Dynamics of Adaptation and Diversification”, Proc. Nat Acad. Sci. 91: 6808-6814, 1994), with significant results apparent in a few days (i.e. in the order of thousands of generations [0(1000) generations]). Despite the rapid adaptation, bacterial communities are also remarkably stable. Fossils of communities (stromatolites) that lived 3.5 billion years ago in Australia appear identical to present day communities living in Shark Bay on Australia's west coast. Bacteria thus have many of the properties (simplicity, resilience, rapid response to change) that are desirable for network entities.

In similar biological systems such as protocists, where the probability of mutation occurring during the copying of a gene is around 1 in a billion, adaptive evolution can occur within 1 m generations (0(1000)yrs). GAs typically evolve much faster since the generation time is 0(100)ms and the mutation rate is raised to 1 in a million but adaptation can still only deal with changes on a time-scale of 0(10)s. Using bacterial learning (plasmid interchange) in a GA will improve this to 0(10)ms, and substantially improve its performance when faced with rapid change.

In the present invention each node posses a set of policies, which mimic the functionality of a bacterial plasmid. The set of policies specifies which type of service request the node is able to process (e.g. a, b, c or d from FIG. 1), and a rule, or rules, that determine whether the node will accept a service request or not. Each node has a certain number of policies and these policies determine how the node responds to the changing environment of the network (in the same way as the genetic material of a bacterium determines how that bacterium responds to its environment). The policies take the form {x,y,z} where:

x is a function representing the type of service requested;

y is a function which determines whether a service request is accepted dependent upon the number of service requests queued at the node; and

z is a function which determines whether a service request is accepted dependent upon the activity level of the node.

The ‘value’ that a node may derive from processing a service request would be receiving revenue from a user or network or service provider (this is analogous to a bacterium gaining energy from metabolising resources, such that the bacterium can survive and potentially reproduce). The quantum of revenue will depend upon the type of service request which is processed by the node, with some service requests being more important and hence providing greater reward when they are processed. Each node may have any number of policies. Enabled nodes (i.e. a node that is processing service requests) will have one or more enabled policies (i.e. policies which are in use to determine the response of the node) and may also have a number of dormant policies (i.e. once enabled policies that are no longer used to determine the response of the node). Dormant policies may be re-enabled and enabled policies may be repressed, becoming dormant.

User requests for service are received by the node(s) nearest the point of entry to the network from the user community generating the service request. If the node is capable of processing the request then the request joins a queue, with each node evaluating the items that arrive in its input queue on a ‘first in, first out’ principle. If the service request at the front of the queue matches an available policy the service request is processed, the node is ‘rewarded’ (i.e. revenue is generated for the network or service operator) and the request is then deleted from the queue. If the service request does not match any of the node's enabled policies then the request is forwarded to another node and no reward is given. The more time a node spends processing service requests, the busier it is and the rewards (or revenue) generated by the node increases. Conversely, if a node does not receive many service requests for which it has an enabled policy then the node is not busy and little reward (or revenue) is being generated by that node. If a node which is receiving service requests, for which it has an enabled policy, at a greater rate than it is capable of processing those requests then the length of the queue of service requests will grow. This will lead to an increase in the time taken to process a service request and hence a poor service will be supplied to the user communities.

In order to reduce these unwanted effects it would be desirable for the nodes which are not busy and/or which have small queue lengths to able to acquire the traits of the nodes which are busy and/or have large queue lengths. One method by which this may be achieved is by adopting a scheme that is an analogue of plasmid migration in bacteria. Plasmid migration involves genes from healthy individuals being shed or replicated into the environment and subsequently being absorbed into the genetic material of less healthy individuals. If plasmid migration does not help weak strains increase their fitness they eventually die. Thus, if a node has a queue length or an activity indicator that reaches an upper threshold value then one of the node's policies may be made accessible to other nodes. If a node has an activity indicator and/or a queue length that reaches a lower threshold then that node may acquire one of these policies that has been donated by successful node (these threshold values (both upper and lower) need not be the same for the queue length as for the activity indicator).

If a node maintains the upper threshold value for the queue length or for the activity indicator for a given period of time (i.e. the node sustains its success) then the node can clone itself by producing another node having the same set of policies as the parent node. This is analogous to healthy bacterium with a plentiful food supply reproducing by binary fission to produce identical offspring. Alternatively, this cloning process may be initiated by the node's queue length or activity indicator reaching a second upper threshold value, this second upper threshold value being greater than the first upper threshold value. Conversely, if a node maintains the lower threshold value for the queue length or for the activity indicator for a given period of time (i.e. the idleness of the node is sustained) then some or all of the enabled policies of the node are deleted and any dormant policies are activated. If the node has no dormant polices then once all the enabled policies have been deleted then the node is switched off. This is analogous to bacterial death due to nutrient deprivation.

Following the analogy with bacterial evolution, it is believed that a slower rate of adaptation to the environmental changes is preferable to a faster rate of adaptation, as a faster rate may mean that the network nodes end up in an evolutionary ‘blind alley’, without the genetic diversity to cope with subsequent environmental changes. This can be achieved by favouring random changes in nodal policies rather than favouring the adoption of successful policies or the rejection of unsuccessful policies.

The other method by which the nodal policies may be varied is analogous to random genetic mutations which occur in bacterium. For example, policy mutation may involve the random alteration of a single value in a policy. If a policy were to have the form:

Accept request for service a if activity indicator <80% then permissible mutations could include (mutation indicated in bold);

Accept request for service c if activity indicator <80%, or

Accept request for service a if activity indicator <60%, or

Accept request for service a if queue length <80%.

Simulations have shown that single value mutations give rise to stable systems with fairly low rates of mutation. Whilst it would be possible to have multiple value mutations (e.g. ‘Accept request for service a if activity indicator <80%’ mutating to ‘Accept request for service b if queue length <20%’) this may lead to an unstable system. Results of simulations show that because of the long-term, self-stabilising, adaptive nature of bacterial communities, which is mimicked by the nodal policies, a network management algorithm based upon bacterial genetic structure and environmental responses provides a suitable approach to creating a stable network of autonomous nodes. The above approach makes each node within the network responsible for its own behaviour, such that the network is modelled as a community of cellular automata. Each member of this community is selfishly optimising its own local state, but this ‘selfishness’ has been proven as a stable community model for collections of living organisms (R Dawkins, “The Selfish Gene”, Oxford University Press, 1976) and partitioning a system into selfishly adapting sub-systems has been shown to be a viable approach for the solving of complex and non-linear problems. Thus overall network stability is provided by a set of cells that are acting for their own good and not the overall good of the network and this node self-management removes most of the high-level network management problems.

The inventors have implemented a simulation of a network according to the present invention (and of the kind described above). The simulated network comprises six inter-connected clusters 21, 22, 23, 24, 25 & 26 (see FIG. 2). Each cluster comprises 500 vertices at which a node may be situated, with 10 rows each containing 50 vertices. Each cluster is able to forward service requests to two of the other clusters and to also receive service requests from two other clusters. For example, cluster 21 can forward requests to, and receive requests from, clusters 22 and 24.

The simulation system supports up to one hundred different service types but in the interest of simplicity the following discussion will refer to a subset of four of these service types; A, B, C, D. The system is initialised by populating a random selection of vertices with enabled nodes. These initial nodes have a random selection of policies which define how each node will handle requests for service. These policies have a number of variables and are represented by the form {x,y,z} where:

x is a function representing the type of service requested;

y is a function between 0 and 200 which is interpreted as the value in a statement of the form

Accept request for service [Val(x)] if queue length <Val(y); and

z is an integer between 0 and 100 that is interpreted as the value in a statement of the form

Accept request for service [Val(x)] if busyness <Val(z%) A node having a number of policies is represented as {x₁,y₁,z₁: x₂,y₂,z₂: . . . : xᵢ,yᵢ,z_{i}}

Requests are input to the system by injecting sequences of characters, which represent service requests, at each vertex in the array. If the vertex is populated by a node, the items join a node input queue. If there is no node at the vertex then the requests are forwarded to a neighbouring vertex. Each node evaluates the service requests that arrive in its input queue on a ‘first in, first out’ principle. If the request at the front of a nodal queue matches an available rule then the request is processed, the node is rewarded for performing the request and the request is deleted from the input queue. If there is no match between the service request and the node's policies then the request is forwarded to another vertex and no reward is obtained by the node. Each node may only process four requests per measurement period (henceforth referred to as an epoch). The more time a node spends processing requests, the busier it is seen to be and the greater the value of its activity indicator. The activity indicator can be determined by calculating the activity-in the current epoch, for example, if the node processed three requests in the current epoch, generating 25 ‘points’ of reward for each processed request, then the activity indicator would be 75. However in order to dampen any sudden changes in behaviour due to a highly dynamic environment it is preferred to combine the activity indicator at the previous epoch with the activity indicator for the current epoch. It has been found for the simulated network that a suitable ratio for the previous indicator to the current indicator is 0.8:0.2. For example, if in this epoch the node has processed three requests with each generating 25 points, and the node had an activity indicator of 65 for the previous epoch then the activity indicator for the present epoch will be 67. It will be seen that the ratio between the two indicators will vary with each system and depend upon how dynamic the system is. It should be also noted that the selection of four processing steps per epoch is an arbitrary choice and that other values may be adopted for this parameter. Service requests that are not processed by a node are forwarded randomly to another node.

The inventors have implemented a new mechanism for plasmid migration by extending the definition of the service request to include the functionality whereby a service request can carry a policy (in a manner analogous to an email message carrying an attachment). If a node is not able to process a service request (and so must forward it) and a random number between 0-100 is less than it's activity indicator then a copy of a policy from that node is attached to the request. Alternatively, if a node is not able to process a service request and its activity indicator plus a constant (typically 5%) is less than a random number between 0-100 then the node may remove take a policy from the policy attachment space, if there is one. If a node successfully processes a service request and its activity indicator plus a constant (currently 5%) is less than a random number between 0-100 then the node may also remove a policy from the policy attachment space if it holds a policy.

Currently, values for queue length and the time-averaged activity indicator are used as the basis for determining whether policies are added or discarded or if replication occurs, and evaluation is performed every five epochs. Both of the threshold values were 30 in this example and it is clear that this value is only an example, other threshold values may be selected and there is no need to have the threshold value for the queue length to be equal to that of the activity indicator. The threshold values will determine the number of nodes which can reproduce to occupy the system and should be chosen suitably to match the performance requirements of the system. If the node continues to exceed the threshold for a number evaluation periods (i.e. 20 epochs), it replicates its entire genome into an adjacent vertex where a node is not present, simulating reproduction by binary fission which is performed by healthy bacteria with a plentiful food supply. The time required for replication to occur varies between 3 and 5 epochs, depending upon the maximum queue length of the node (with nodes having large maximum queue lengths needing to exceed the threshold for longer than for nodes having short maximum queue lengths). Offspring produced in this way are exact clones of their parent.

If the activity indicator is below a different threshold, for example 10, then the node is classified as idle. If a node is ‘idle’ for three evaluation periods (i.e. 15 epochs), its enabled policies are deleted. If any dormant policies exist these are enabled, but if there are no dormant policies then the node is switched off. This is analogous to bacterial death by nutrient deprivation. If an imported policy does not increase the activity indicator of the node such that the node is no longer idle then a further policy may be imported from a service request having an attached policy; if there is no such policy to be imported then the node may be deleted.

A visualisation environment was created for this implemented simulation. The visualisation environment provides an interface where network load and other parameters can be varied in many ways, thereby allowing stresses to be introduced into the system in a flexible manner. For instance, the ratio of requests for the services can be made to vary over time, as can the overall number of requests per unit time. Rules governing reproduction and evolution, including plasmid migration (as described above), were introduced into the simulation, in an attempt to force the nodes to model the behaviour of bacterium in a changing environment. For the simulations discussed below the four different policies had time to live (TTL) values of 2, 5, 10 and 20 hops respectively and were injected into the clusters in equal proportion. The injection rate was approximately 25% of the maximum allowed by the simulation model, leading to approximately 50% of the vertices in the clusters to be populated at any given time. The clusters are arranged in a rectangular array of 50×10 vertices with all requests for services arriving at the nodes along one of the longer edges of the cluster, with requests arriving with equal probability at the 50 nodes in the uppermost row of the cluster (it will be understood that the orientation of the rectangular cluster and the arrival of the requests at the uppermost layer of the cluster are arbitrary. The service requests could arrive at the lowest layer of the cluster and travel upwards through the cluster, or the cluster could be rotated through 90θ with the requests arriving at either of the longer edges. Equally, the requests could arrive at one the shorter edges of the cluster. The size and proportion of the cluster are merely exemplary and are not critical to the working of this embodiment of the invention).

As the various service requests arrive at the uppermost layer of the cluster, if they arrive at a node which possesses a suitable policy for processing the request then the request is processed and the activity indicator of the node benefits accordingly. If the service request can not be processed by the node then the service request will be forwarded, either along the top row of the array or down to the second layer of the array. FIG. 3 shows the probabilities for a service request being forwarded from node X. The choice of these probabilities is designed to promote the migration of forwarded requests down through a cluster thus, it will be seen that the general tendency of service requests will be to migrate down through the array before they arrive at a node that is capable of processing the service request. If the service request is to be forwarded beyond the bottom of its cluster then the request is forwarded to the uppermost layer of one of the clusters to which its original cluster may forward requests. If there is more than one cluster to which a request may be forwarded then one may be chosen randomly, or on a turn-wise basis or some cluster parameter may be used as the basis for a decision. The service request is injected into a column that preferably is chosen randomly, although it may be injected into the column corresponding to the column from which it left its originating cluster (additionally, if un-processed service requests are forwarded beyond the width of a cluster then the request may be forwarded to a different cluster).

The two main implications of the tendency of service requests to migrate down through a cluster are that

service requests with short TTL values have a requirement that nodes capable of processing those service request types are more prevalent in the upper layers of the array so that the service request can be processed before they time out; and

there is a selective advantage for the nodes in the uppermost layers of the array as they are closest to the supply of resource which, unless there is some form of compensating mechanism, will lead to those nodes having policies for as many different types of service request as possible. This will lead to the stockpiling of as many service requests as possible in their input queues in an attempt to maintain their activity indicator at a high level and provide a buffer in the event of a prolonged period of time in which there is a low request rate.

Occupying a position in the uppermost layers of the array will provide an advantage to all nodes, but some nodes will be more advantaged than others by this. It is obvious that nodes that process predominantly short TTL requests will be better positioned at or near to the supply of service requests to the network, but nodes processing predominantly long TTL requests may also benefit by being near the point of request origin. A request having a long TTL may be processed equally well after passing through several layers of the network as if it had been processed at the edge of the network, but although a node may be thriving on the ninth layer of the array if it produces clones that populate the eight layer of the array then the clones will start taking some of the parent's potential requests, thereby decreasing the viability of the parent node.

To try and encourage discerning use of all areas of the network, several penalties were introduced for nodes that effected their performance depending on their position. One of the nodal characteristics that is used to determine the preferential survival and reproduction of a node is the maximum length of its queue. Due to the essentially selfish nature of the nodes there is selective pressure to evolve as big a ‘maximum queue size’ as possible, thereby keeping a large reservoir of requests for periods of low request rate. To counteract this obvious benefit of long maximum queue lengths a penalty was introduced to a node for allowing a request to ‘die’ in its queue. If a node accepts a request onto its queue that has exceeded its TTL by the time the node attempts to process it, the node receives a penalty, for example a reduction of the activity indicator by 4 points.

A more indirect penalty was created by penalising nodes that passed on requests with short times to live after realising they do not contain a policy to process the request. It is very anti-social to forward a near ‘dead’ request to the bottom of a neighbouring node's pile of requests (given the aforementioned timeout penalty) so nodes are penalised for forwarding a request based on the remaining TTL of that request. This should put evolutionary pressure on nodes to restrict the maximum length of their queues, as there is no penalty for not accepting a request. This penalty function has an effect on the optimal position of a node. If a node processes predominantly requests having a long TTL, occupying a prominent position in the network would mean it would have to forward all requests having a short TTL and incurring penalties for this. It is advantageous for these nodes to reside where the short TTL requests have already been processed, i.e. in the lower layers of the array. Although these penalties have been implemented by directly reducing the activity indictor of the node, it is also possible to penalise nodes by reducing the time window that they have to process requests

The simulation also includes an additional mechanism that is an analogy of tropism, which is the response of plants and lower order animal forms to a stimulus that has a greater intensity from one direction than another. For example, most plant seeds exhibit phototropism (a response to light) by sending shoots to maximise the effects of photosynthesis and hydrotropism (a response to water) by sending root systems to maximise water uptake from their environment. Each node has a tropism value encoded within its genome, which can be within the range 0 to 1, and which can effect the manner in which the node reproduces by binary fission (note that the tropism value is not transferred during plasmid migration). The tropism value of a node may be altered by a random mutation. If a node has a tropism value of greater than 0.5, its offspring will spawn directly to the left (at a 25% probability), directly to the right (at a 25% probability) or directly above the parent node (at a 50% probability). Alternatively, if the node's tropism value is 0.5 or less then its offspring will spawn directly to the left (at a 25% probability), directly to the right (at a 25% probability) or directly below the parent node (at a 50% probability). This allows some strains of nodes to evolve a preference for living in the upper levels of the array and other strains to prefer a life in the lower levels of the array. Those nodes that have a low tropism value are likely to process predominantly long TTL service requests due to their preference for the lower levels of the array, whilst those nodes having a high tropism value are likely to possess policies enabling them to process predominantly short TTL service requests due to their preference for the upper levels of the array.

As an alternative to the ‘death’ of nodes which have only unproductive policies, a node that is about to ‘die’ may sometimes change position with the node directly above or directly below them, allowing a node to move in a preferred direction where it may find more suitable conditions even if it's path is blocked by another node. The direction of the move is dependent upon the tropism value of the under-performing node with low tropism value nodes moving down the array whilst high tropism value nodes will move up the array. Simulation has shown that a suitable probability for allowing such a positional switch to occur is 10%.

FIG. 4 shows some simulation results for a cluster from a network according to the present invention. Those nodes without a numerical indicator are of a general nature Whilst those with a numerical indicator have adapted to handle service requests with particular TTL values with the indictor increasing in value as the TTL limit increases. FIG. 4a is a snapshot of the simulation after it has been run for 15 epochs and the random nature of the distribution of nodes is very much apparent. FIGS. 4b and 4c are snapshots taken after a longer period of simulation (200 and 800 epochs respectively) and they show the layering that occurs, with the type 1 and type 2 nodes predominating towards the top of the cluster and the type 3 and type 4 nodes predominating towards the bottom of the cluster. These results show that nodes within clusters adapt to specialise service requests that have different properties, and that there is a tendency for the nodes in a cluster to organise themselves within the cluster so as best cope with the service request variants.

FIGS. 5a & 5b show the results of a comparison of the performance of an adaptive network according to the present invention and a fixed network (in which each cluster is randomly populated with nodes which contain a fixed number of policies, which do not evolve, are not able to mimic plasmid exchange and can not replicate) . FIG. 5a shows the consumption efficiency of the colony against simulated time. As might be expected the properties of the random colony do not change with time. For the network according to the present invention, two timescales of evolution are apparent. There is a fast initial transient due to the sharing of plasmids (shown in the upsurge in efficiency in the first 100 epochs of the simulation) and a slower improvement due to the continuing evolution and sharing of novel plasmids via random mutations. The evolved colony, in general, performs somewhat better than the random colony (converging towards an efficiency value of 80% as opposed to 70% for the fixed network with far fewer activated nodes (1000 for the evolved network and 2000 for the fixed network). Perhaps more significantly when a new nutrient is introduced to the evolved network it adapts, whereas the random network does not (the graph does not show this since the new nutrient was only 1% of the total input and the small performance changes cannot be resolved at this scale).

The evolved network also copes well with uneven distributions of the injected nutrients. FIG. 5b shows the effect of progressively concentrating nutrient input into fewer sub-colonies. The x-axis has an even distribution of input (at 80% max as in FIG. 5a) into the top edge of all six clusters. The input is concentrated until the supply to one cluster is the max possible, and the other clusters are fed so that the total number of service requests remains constant. It is clear that at all times the evolved network is more effective than the random network. This final graph is particularly interesting since the network is behaving in exactly the way that a good distributed load balancing algorithm should. It is spreading load across available resources, ensuring a high probability of success (comparable to real computing systems at high load), whilst minimizing the resources required. The inventors are confident that by appropriate adjustment of the simulation parameters the success rate could be increased to any desired value, and required resources would always be less than for a static distribution of resources.

It will be immediately obvious that the control parameters given above are merely exemplary and are provided to illustrate the present invention. The optimal values of the different parameters will vary from system to system depending upon the number and type of service requests that are to be processed by the network.

Networks according to the present invention have the advantage that they can be upgraded to provide additional services by inserting new policies defining these services into the network. The simplest method of achieving this is to allow nodal policies to mutate so that a policy can process the new type of service request(s). If a policy mutates such that it can process a new service request type then the node will have an abundant food source, which will aid the distribution of the newly mutated policy through the nodal population, by plasmid migration and/or by reproduction.

Another method of enabling nodes to process new types of service request is to modify the policy set of an existing node so that it can handle the new service type. In order to do this it will be necessary to disable the node for a short period of time, but the distributed nature of the network means that other nodes will react to accommodate the missing node. However, it would be easy to introduce a new policy type by attaching it to one or more service requests as they are injected into the clusters. Due to the evolutionary nature of the network if a given service type is not used extensively then the number of nodes having suitable policies for that service type will decrease as the nodes die out or adapt to process other service types.

It can be seen from the simulation results that it is possible to create different qualities of service within such a network by defining the value derived from processing a service request and/or the time to live for a service request. The quality of service (QoS) provided by the network may be controlled by the network operator or service provider defining constant values for these variables for different types of service request or having different classes of QoS available for the same service, with the user selecting a desired class of QoS. Alternatively, the users may choose a suitable level of QoS, or a cost level that they are prepared to pay, with this choice then being translated into a suitable combination of service request value and/or time to live. Additionally, the QoS process may be more transparent, with users selecting directly the service request value and/or time to live for some or all of their network transactions.

An example of such a multi-service network is as described by M Fry & A Ghosh, “Application Level Active Networking”, available from http://dmir.socs.uts.edu.au/projects/alan/papers/cnis.ps. Each cluster would contain a number of large scale active network nodes (ANNs), with each ANN comprising a large processor cluster, for example up to 200 processors, with each processor running a dynamic proxylet server (DPS) and around 10 Java virtual machines (JVMs), each of which contain one or more proxylets (a proxylet is a small program that implements an active network service, such as transcoding a data resource from one format to another e.g. from a QuickTime video stream to a RealPlayer video stream, or,from CD format audio to MP3 format audio).

Each DPS controls and implements the algorithmic rules discussed above that determine the activity indicator levels at which nodes may reproduce, export nodal policies, import nodal policies, etc. The JVMs are the nodes (i.e. analogous to bacterium) with the proxylets (or policies pointing to the proxylets and authorising execution) providing the nodal policies (i.e. the genes of the bacteria).

In use, the proxylets are mostly multi-user devices, but they may be installed and used by a single user. A proxylet may be installed by a user who then proceeds to load the proxylet by making suitable service demands (this is analogous to placing a nodal policy into a node and then injecting some requests for the service it represents). Only at very low traffic loads will a given proxylet not be present at all the ANNs, but this gives rise to efficient network resource utilisation as proxylets are run only in response to user demand and are run at a convenient network location.

The nodes of the simulated network do not have any awareness of the concept of an ANN or the boundaries between the different ANNs that comprise a network. The main reasons for this is to minimise the complexity of the nodal operations and because of the fuzzy nature of the boundaries in a cluster model.

The simulation indicates that such an active network should be capable of implementation and that reasonable levels of performance achieved. The ability to manage the deployment of new services over such networks has also been successfully simulated.

1. A multi-service communications network comprising a plurality of clusters, each cluster comprising more than one node and being connected to one or more other clusters,
each node comprising one or more nodal policy and being configured to process one or more services in accordance with said one or more nodal policy, each nodal policy comprising;
(i) a service request identifier, said service request identifier determining the type of service request that may be processed by each respective node; and
(ii) one or more service request criteria, said service request criteria determining whether a type of service request defined by said service request identifier will be processed by each respective node
characterised in that, in use, un-processed service requests are forwarded to other nodes within a cluster and un-processed service requests which reach the perimeter of the cluster are forwarded to one of the connected clusters.

2. A multi-service communications network according to claim 1, in which a service request may contain a nodal policy.

3. A multi-service communications network according to any preceding claim such that if the activity indicator reaches an upper threshold then the node replicates all of the nodal policies to generate a clone of the node.

4. A multi-service communications network according to claim 2, such that if the activity indicator reaches a first lower threshold then the node may import the policy contained in the service request.

5. A multi-service communications network according to claim 4 such that if the activity indicator reaches a second lower threshold then the node deletes an enabled nodal policy and enables a dormant nodal policy.

6. A multi-service communications network according to claim 4 such that if the activity indicator reaches a second lower threshold then the node exchanges position with an adjacent node.

7. A multi-service communications network according to any preceding claim wherein service requests are injected into the uppermost layer of the cluster.

8. A multi-service communications network according to any of the preceding claims herein a variable within a nodal policy is randomly varied.

9. A multi-service communications network according to any of the preceding claims wherein each node further comprises a variable that encodes a preference for existing in a defined region of a cluster.

10. A data carrier comprising computer code means for implementing a multi-service communications network according to any preceding claim.

11. A method of operating a multi-service communications network according to any of claims 1 to 9.
